(19) United States
(12) Patent Application Publication
(10) Pub. No.: US 2022/0334303 A1
(43) Pub. Date: Oct. 20, 2022

(54) LIGHTGUIDE TYPE ILLUMINATION DEVICE WITH SYMMETRICALLY ARRANGED MULTIPLE COLOR LIGHT SOURCES

(71) Applicant: HEWLETT-PACKARD DEVELOPMENT COMPANY, L.P., Spring, TX (US)

(72) Inventor: Kyoungrok KIM, Seongnam-si (KR)

(73) Assignee: HEWLETT-PACKARD DEVELOPMENT COMPANY, L.P., Spring, TX (US)

(21) Appl. No.: 17/762,915

(22) PCT Filed: Oct. 20, 2020
(86) PCT No.: PCT/US2020/056477

§ 371 Date: Mar. 23, 2022

(30) Foreign Application Priority Data
Oct. 23, 2019 (KR) 10-2019-0131931

(51) Int. Cl. F21V 8/00; H04N 1/028; H04N 1/10

(52) U.S. Cl. CPC G02B 6/0038; G02B 6/0068; H04N 1/02835; H04N 1/1061; H04N 1/1039

(57) ABSTRACT

An illumination device includes a light guide member having a first side in a main scanning direction and a second side in a sub-scanning direction and a plurality of light sources including first light emitters respectively to emit beams of light of a first color and a second light emitter to emit a beam of light of a second color different from the first color toward an inside of the light guide member via a side of the light guide member in the main scanning direction. The first light emitters are positioned in the sub-scanning direction to be symmetrical to each other.

### BACKGROUND

A scanner irradiates a document with light by using an illuminating device, images light reflected from the document onto an image sensor by using an imaging optical system, and obtains image data by photoelectrically converting a formed optical image into an electrical signal. An image sensor is a one-dimensional linear image sensor having a length in a main scanning direction. The scanner may continuously read a one-dimensional image via an image sensor while moving a scan module in a sub-scanning direction and produce a two-dimensional image by performing image processing on the read image data.

### BRIEF DESCRIPTION OF THE DRAWINGS

FIG. 1 is a structural schematic diagram of a scanner according to an example.

FIG. 2 is a structural schematic diagram of a scanner according to an example.

FIG. 3 is a perspective view of an illumination device employed in the scanners of FIGS. 1 and 2, according to an example.

FIG. 4 is a side view of a light guide member shown in FIG. 3, according to an example.

FIG. 5 shows an example of shading profile for an image sensor, according to an example.

FIG. 6 illustrates light distributions on a surface of a document illuminated by five LEDs shown in FIG. 4, according to an example.

FIG. 7 shows a result of combining light distributions for two LEDs symmetrically positioned with respect to each other in a sub-scanning direction, according to an example.

FIG. 8 illustrates a light distribution based on an arrangement of R-G-B-G-R, according to an example.

FIG. 9 illustrates examples of various arrangements of a plurality of light sources.

### DETAILED DESCRIPTION

According to an example, one or both of two methods may be used to obtain color image data. One method involves irradiating or illuminating a document with white light by using an illumination device, splitting light reflected from the document into red (R), green (G), and blue (B) color beams, and respectively receiving the R, G, and B color beams at R, G, and B sensing regions on an image sensor. The other method involves irradiating or illuminating a document with three different color beams, i.e., R, G, and B color beams, by using an illumination device and sequentially receiving the three color beams via a monochromatic image sensor.

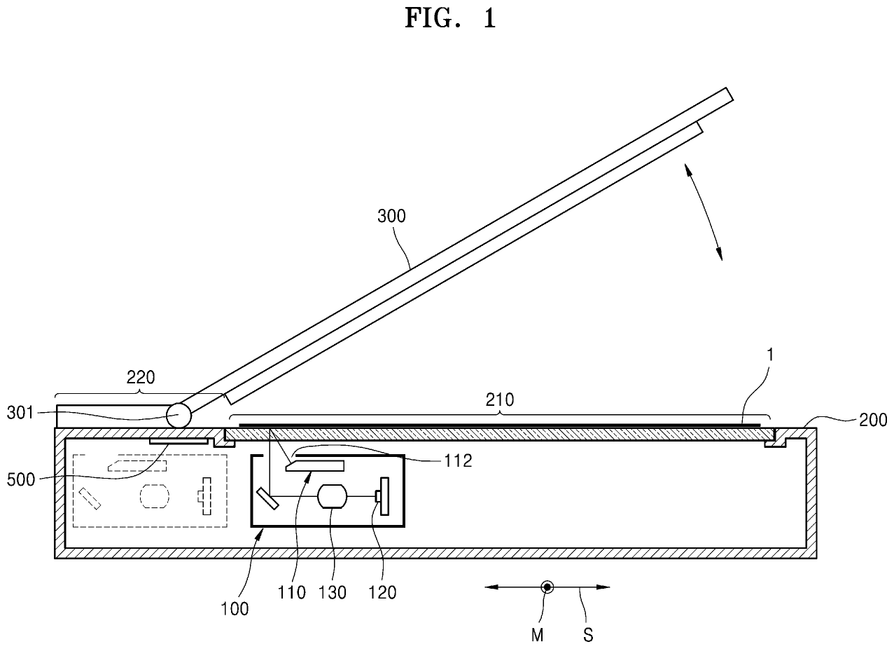

FIG. 1 is a structural schematic diagram of a scanner according to an example. Referring to FIG. 1, the scanner includes a document board 200 on which document 1 is placed and an image reading module 100 to be moved in a sub-scanning direction S. The image reading module 100 irradiates or illuminates with light or project light on an object of which image information is read, such as the document 1 placed on the document board 200, and receives light reflected from the document 1 for photoelectric conversion. The image reading module 100 may include an illumination device 110 that irradiates or illuminates the document 1 with light or project light on the document 1, an image sensor 120, and an imaging optical system that images light reflected from the document 1 onto the image sensor 120.

The illumination device 110 may sequentially irradiate or illuminate the document 1 with red (R) light, green (G) light, and blue (B) light for color scanning. Light emitted by the illumination device 110 and projected onto the document 1 passes through the imaging optical system 130 to reach the image sensor 120. The image sensor 120 photoelectrically converts an optical signal into an electrical signal. According to an example, the image sensor 120 may be a charge coupled device (CCD) image sensor, a complementary metal-oxide semiconductor (CMOS) image sensor, or the like. The image sensor 120 is a monochromatic sensor.

The image sensor 120 may be a one-dimensional sensor having a length in a main scanning direction M. In order to obtain two-dimensional image data, at least one of the illumination device 110, the imaging optical system 130, and/or the image sensor 120 may be moved in a sub-scanning direction S. According to an example, the image reading module 100 including the illumination device 110, the imaging optical system 130, and the image sensor 120 is entirely moved in the sub-scanning direction S. The length of the image sensor 120 in the main scanning direction M is less than a length of the document 1 in the main scanning direction M. Thus, the imaging optical system 130 may be a reduction imaging optical system that reduces light reflected from the document 1 in the main scanning direction M to form an image on the image sensor 120. The imaging optical system 130 may include one or more lenses.

The document board 200 may include a light-transmissive reading region 210 on which the document 1 is placed and a home position region 220. The light-transmissive reading region 210 is formed of a transmissive material such as glass that is able to transmit light. The home position region 220 is positioned on a side of the light-transmissive reading region 210 in the sub-scanning direction S. The image reading module 100 may be located in the home position region 220 when a scan operation is not performed. When the image reading module 100 is located in the home position region 220, it is understood that at least a light transmission window 112 through which illumination light and light reflected from the document 1 passes moves away from the light-transmissive reading region 210 to the home position region 220. A shading sheet 500, which is to provide a reference for correcting shading, may be provided in the home position region 220. The image reading module 100 may read the shading sheet 500 while moving from the home position region 220 to the light-transmissive reading region 210.

The scanner may further include an upper cover 300 for covering at least the light-transmissive reading region 210 of the document board 200. The upper cover 300 may be rotated around a hinge 301 to a position where an upper portion of the light-transmissive reading region 210 is exposed and a position where the light-transmissive reading region 210 is covered, such that the document 1 may be placed on the light-transmissive reading region 210.

When a scan start signal is input by a host (not shown) or an operation panel (not shown) of the scanner, the image reading module 100 moves in the sub-scanning direction S and performs a scan operation. The optical signal, which is reflected from the document 1 and received on the image sensor 120 via the imaging optical system 130, is photoelectrically converted into an electrical signal by the image sensor 120. The electrical signal is converted into a digital value by an analog-to-digital (AD) converter (not shown). An image processor (not shown) may write image data from digital values, and store the image data in a storage device such as a memory (not shown) or output the same to an external device (not shown) such as a printer or a host device.

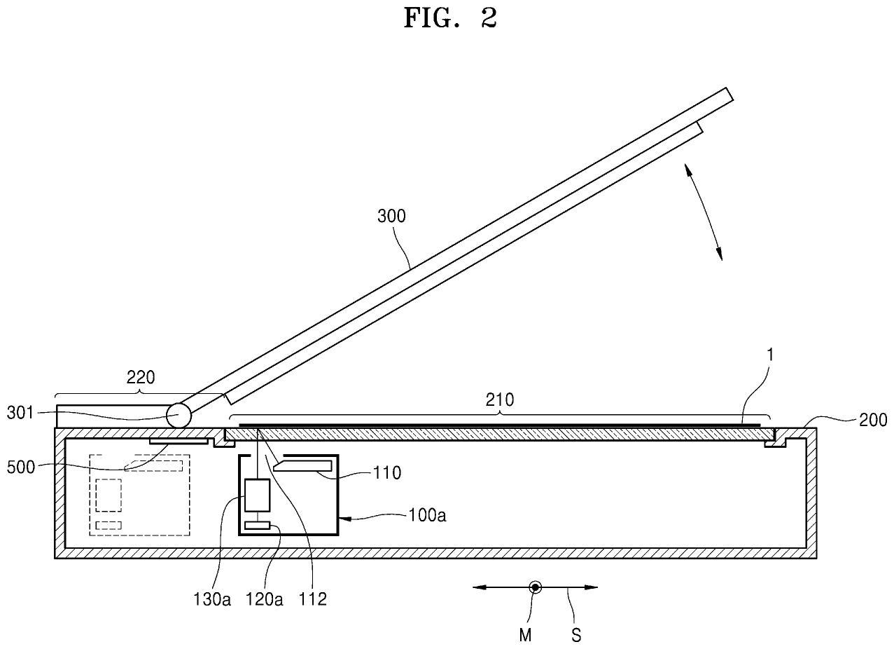

FIG. 2 is a structural schematic diagram of a scanner according to an example, which is different from an example of the scanner described with reference to FIG. 1 in that the scanner includes an image reading module 100a in the form of a contact image sensor (CIS) module. Thus, elements having the same functions are denoted by the same reference numerals, and only the difference from the scanner of FIG. 1 will be briefly described.

The image reading module 100a includes an illumination device 110 that irradiates or illuminates a document 1 with light, an image sensor 120a, and an imaging optical system 130a that images light reflected from the document 1 onto the image sensor 120a, and moves in a sub-scanning direction S. The image reading module 100a irradiates or illuminates with light an object of which image information is read, such as the document 1 placed on a document board 200, and receives light reflected from the document 1 for photoelectric conversion.

For example, the image sensor 120a may include a CMOS sensor array arranged in a main scanning direction M. A length of the image sensor 120a in the main scanning direction M may be equal to or greater than a length of the document 1 in the main scanning direction M. A Selfoc Lens Array (SLA) with a plurality of micro lenses arranged in the main scanning direction M is employed as the imaging optical system 130a. The image reading module 100a, which is compact, may be implemented in such a configuration.

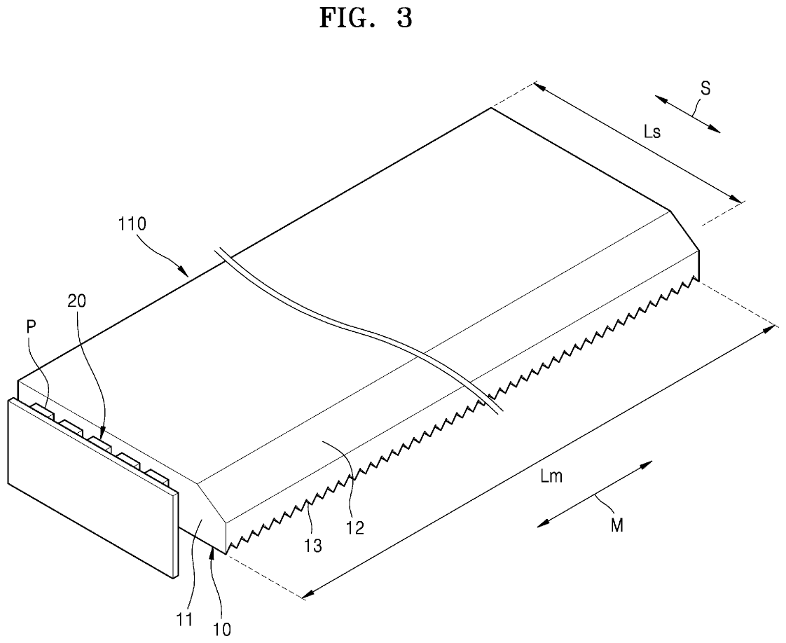

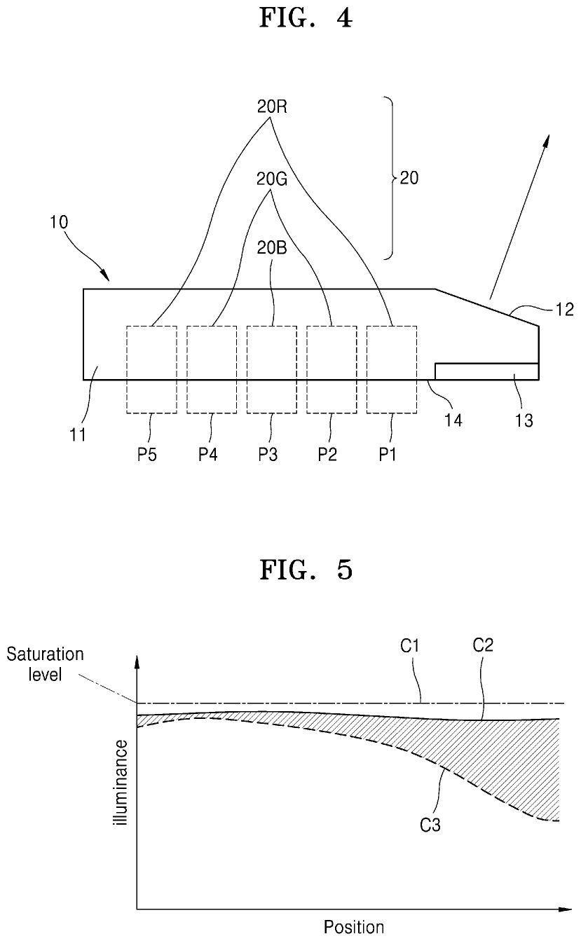

FIG. 3 is a perspective view of the illumination device 110 employed in the scanners described with reference to FIGS. 1 and 2, according to an example, and FIG. 4 is a side view of a light guide member 10 shown in FIG. 3, according to an example. Referring to FIGS. 3 and 4, the illumination device 110 includes the light guide member 10, which has a length Lm in a main scanning direction M (a side having a length Lm in a main scanning direction M) and a length (e.g., as a width) Ls in a sub-scanning direction S (a side having a length (e.g., as a width) Ls in a sub-scanning direction S) and has a light exit portion 12 provided at one end thereof in the sub-scanning direction S to allow light to exit, and a plurality of light sources 20 configured to emit beams of light of different colors towards the inside of the light guide member 10 via a side 11 of the light guide member 10 in the main scanning direction M. The plurality of light sources 20 may include two or more light emitters P that emit light of the same color. The plurality of light sources 20 are arranged such that the two or more light emitters P are symmetrically positioned in the sub-scanning direction S to be symmetrical to each other.

The light guide member 10 may have a rod shape and be formed of a light-transmissive material. According to an example, the light guide member 10 may have a rectangular cross-section and may be of a rod shape extending in the main scanning direction M. The length Lm of the light guide member 10 in the main scanning direction M may be greater than a length of the document 1 in the main scanning direction M. Light entering the light guide member 10 through the side 11 of the light guide member 10 in the main scanning direction M propagates in the main scanning direction M and the sub-scanning direction S due to total internal reflection and exits the light guide member 10 through the light exit portion 12. The light exit portion 12 may be provided at the one end of the light guide member 10 in the sub-scanning direction S. According to an example, the light exit portion 12 may be formed by a surface cut obliquely to the one end of the light guide member 10 in the sub-scanning direction S.

The light guide member 10 may include a scattering pattern 13. The scattering pattern 13 is provided at a position opposite to the light exit portion 12 and emits light to the light exit portion 12. For example, the scattering pattern 13 may include various patterns such as a triangular pattern arranged in the main scanning direction M, a dot pattern scattering light, etc. The scattering pattern 13 may be provided at the position opposite to the light exit portion 12. In the example, the scattering pattern 13 may be positioned on a bottom surface 14 opposite to the light exit portion 12 of the light guide member 10. Light propagating in the light guide member 10 in the main scanning direction M and the sub-scanning direction S due to total internal reflection is scattered by the scattering pattern 13 and exits the light guide member 10 through the light exit portion 12.

According to an example, as described above, the illumination device 110 sequentially irradiates the document 1 with R light, G light, and B light for color scanning. To achieve this, the plurality of light sources 20 include first through third light sources 20R, 20G, and 20B that respectively emit R light, G light, and B light, respectively. Each of the first through third light sources 20R, 20G, and 20B may include one or more light emitters P such as light-emitting diodes (LEDs). As the illumination device 110 of high illuminance is required due to an increased scanner speed, at least one of the first through third light sources 20R, 20G, and 20B may include two or more light emitters P such as LEDs.

The illumination device 110 having a structure in which light is incident via the side 11 of the light guide member 10 as described above is called an edge-light type illumination device. In the edge-light type illumination device, arrangement positions of the plurality of light sources 20 may sensitively affect light distribution in the main scanning direction M on an illuminated surface such as a surface of the document 1. Because high illuminance LEDs usually have a larger chip size, a length of an LED in a single direction such as in the sub-scanning direction S may be 2 mm or more. This means that when a plurality of LEDs are arranged on the side 11 of the light guide member 10, a distance between adjacent LEDs may be at least 2 mm or more. Due to an increase in a distance between LEDs, illuminance distribution may become non-uniform in an area of several tens of millimeters on the surface of the document 1 in the main scanning direction M.

In the scanner, the uniformity of distribution of light from the illumination device 110 in the main scanning direction M is demanded for the following reasons:

First, the light distribution may affect a signal-to-noise ratio (SNR). Illumination light is eventually converted into an electrical signal by the image sensor 120. High illuminance produces a high-strength electrical signal, while low illuminance produces a low-strength electrical signal. In this case, the higher the strength of an electrical signal, the higher SNR that may be obtained in the process of converting light received by the image sensor 120 into an electrical signal. A high SNR may provide high quality scanned image information with low noise. Low noise contributes to improving gray scale characteristics and color reproduction characteristics of a scanned image. Thus, non-uniform distribution of illumination light in the main scanning direction M may cause an image quality difference according to a position of a scanned image in the main scanning direction M.

Second, uniform light distribution contributes to achieving a relatively high illuminance. The image sensor 120 has a specific illuminance level at which sensitivity saturation occurs. Thus, to obtain normal image information, the intensity of illumination light needs to be adjusted such that sensitivity saturation may not occur in the image sensor 120. FIG. 5 illustrates an example of a shading profile for the image sensor 120. In FIG. 5, the ordinate and abscissa respectively represent illuminance and a position in a main scanning direction M. C1 shows a saturation luminance level of the image sensor 120, C2 shows a uniform light distribution, and C3 shows a non-uniform light distribution. The illuminance needs to be less than a saturation luminance level at all positions in the main scanning direction M. As shown in FIG. 5, in an illumination device exhibiting a non-uniform light distribution, an average illuminance reaching a surface of a document is less than an average illuminance in an illumination device exhibiting a uniform light distribution thereon. Thus, implementation of an illumination device with a uniform light distribution may increase the total illuminance that may be received on the surface of the document and accordingly, improve average image noise characteristics.

Thus, when at least one of the first through third light sources 20R, 20G, and 20B includes two or more light emitters P, a method of achieving uniformity of light distribution in the main scanning direction M is required.

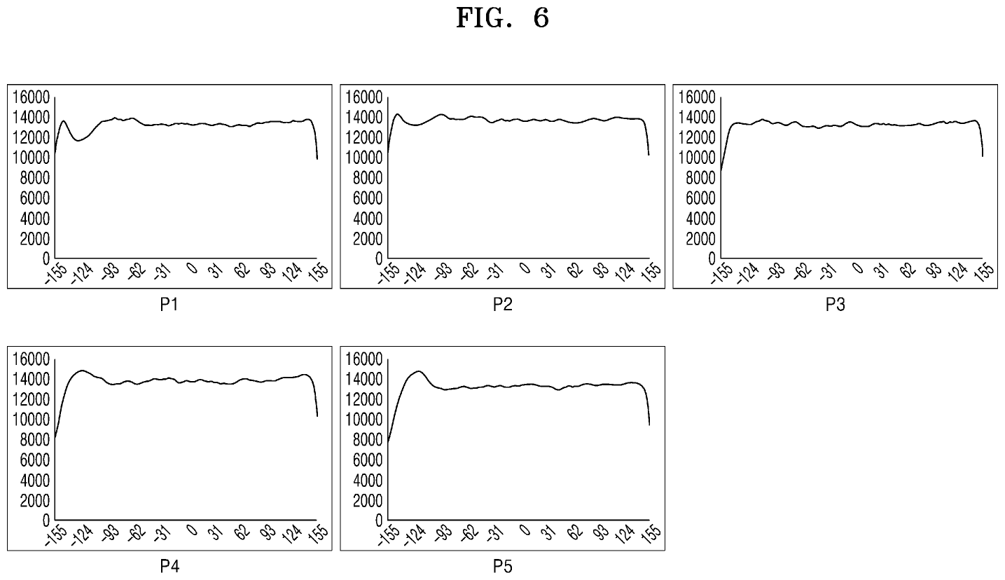

Referring to FIG. 4, five light emitters P, e.g., five LEDs, are respectively arranged at positions P1 through P5 on the side 11 of the light guide member 10. FIG. 6 illustrates light distributions on a surface of a document illuminated by five (5) LEDs, according to an example. In FIG. 6, the ordinate and abscissa respectively represent illuminance and a position in a main scanning direction M. As seen on FIG. 6, a light distribution is sensitively affected by a position at which each LED is arranged. An illuminance at a position close to the side 11 of the light guide member 10 increases as an LED is positioned away from the light exit portion 12 in the sub-scanning direction S. The scattering pattern 13 is determined such that light emitted from an LED located at the position P3 that is a central position is distributed uniformly in the main scanning direction M.

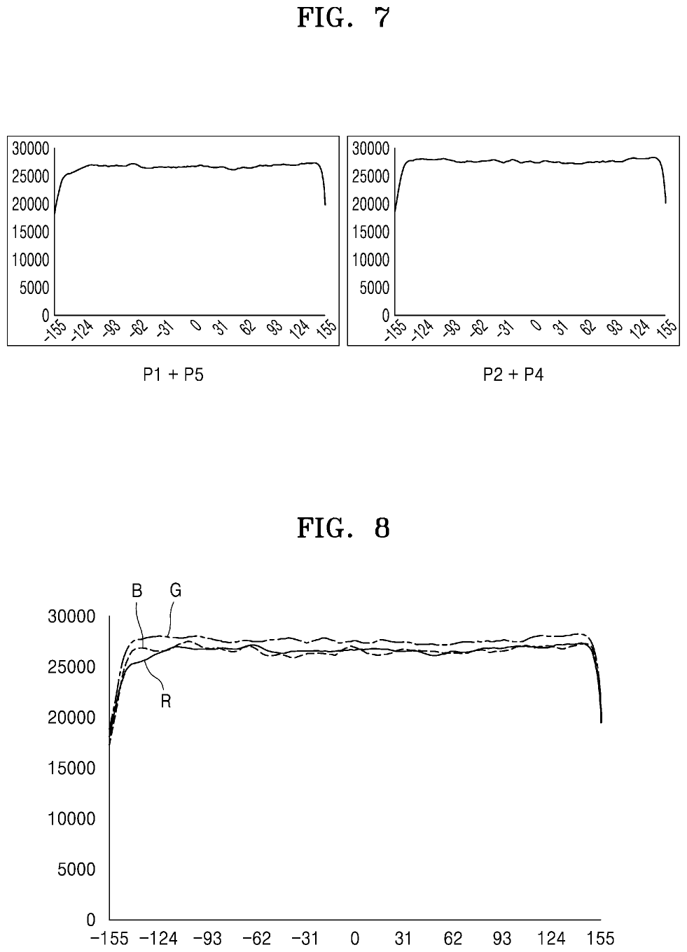

FIG. 7 shows a result of combining light distributions in two LEDs symmetrically positioned with respect to each other in the sub-scanning direction S, according to an example. In FIG. 7, P1+P5 is a result of combining light distributions in LEDs at positions P1 and P5, and P2+P4 is a result of combining light distributions in LEDs at positions P2 and P4. As seen on FIG. 7, combining the light distributions in two LEDs symmetrically arranged with respect to each other may achieve a very uniform light distribution in the main scanning direction M. It can be seen, based on this result, that when two light emitters P emitting the same colored light are arranged at positions symmetric with respect to each other in the sub-scanning direction S, this arrangement of the two light emitters P allows a very uniform light distribution on a surface of a document.

For example, when five LEDs are used, two LEDs (R-LEDs) emitting R light and two LEDs (G-LEDs) emitting G light with relatively low luminance, and one LED (B-LED) emitting B light may be employed. In this case, the two R-LEDs are respectively arranged at the positions P1 and P5 to form the first light source 20R, and the two G-LEDs are arranged at the positions P2 and P4 to form the second light source 20G, and the B-LED may be located at the position P3 to form the third light source 20B. The scattering pattern 13 may be formed so that the light distribution in the B-LED positioned at the center in the sub-scanning direction S is uniform. For example, a shape, size, density in the main scanning direction M, etc., of a unit pattern forming the scattering pattern 13 may be determined so that the light distribution in the B-LED positioned at the center in the sub-scanning direction S is uniform. When the first light source 20R is driven, the two R-LEDs are simultaneously turned on, and when the second light source 20G is driven, the two G-LEDs are simultaneously turned on. FIG. 8 illustrates a light distribution due to arrangement of red (R)-green (G)-blue (B)-G-R LEDs. As seen on FIG. 8, a uniform light distribution is achieved for all of R light, G light, and B light.

According to the results of the above experiments, the plurality of light sources 20 include two or more light emitters P for emitting light of the same color and are arranged such that the two or more light emitters P for emitting the light of the same color are symmetrically positioned with respect to each other in the sub-scanning direction S. The scattering pattern 13 is formed to achieve a uniform distribution of light in the main scanning direction M, which is emitted from a light source, such as a light emitter P, located at the center in the sub-scanning direction S from among the plurality of light sources 20. By virtue of this configuration, uniform light distributions in the main scanning direction M may be achieved for beams of light of all colors.

The plurality of light sources 20 may be arranged in various configurations. LEDs (R-LED and G-LED) respectively emitting R light and G light may have a relatively low luminance compared to an LED (B-LED) emitting B light. Furthermore, the LED (G-LED) emitting G light may have a relatively low luminance compared to the LED (R-LED) emitting R light. In consideration of this, at least one of the first light source 20R and the second light source 20G may have a greater number of light emitters P than the number of light emitters for the third light source 20B. The second light source 20G may include two or more light emitters P. Each of the first and second light sources 20R and 20G may include two or more light emitters P. For example, each of the first through third light sources 20R, 20G, and 20B may include an equal number of light emitters P, or the third light source 20B may include a greater number of light emitters P than the number of light emitters P for the first or second light source 20R or 20G. The number of light emitters P for the first through third light sources 20R, 20G, and 20B may be properly determined to achieve uniformity of light distribution and luminance demanded for each color.

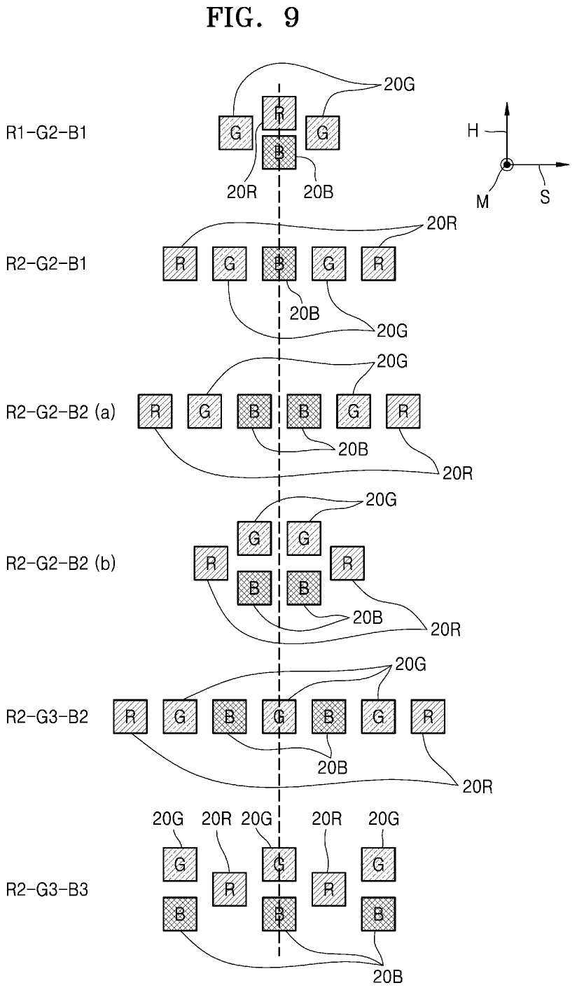

FIG. 9 illustrates examples of various arrangements of the plurality of light sources 20. In FIG. 9, R, G, and B respectively represent light emitters for emitting R light, G light, and B light. Arrangements of the plurality of light sources 20 shown in FIG. 9 are merely examples, and various other arrangements are possible.

R1-G2-B1 represents an arrangement when the first light source 20R includes one light emitter R, the third light source 20B includes one light emitter B, and the second light source 20G includes two light emitters G. In this case, the first and third light sources 20R and 20B may be arranged in a height direction H orthogonal to the main scanning direction M and the sub-scanning direction S and may be located between the two light emitters G forming the second light source G. The scattering pattern 13 is formed to achieve a uniform distribution of light in the main scanning direction M, which is emitted from the first and third light sources 20R and 20B located at the center in the sub-scanning direction S from among the plurality of light sources 20. By virtue of this configuration, a uniform light distribution in the main scanning direction M may be achieved for beams of light of all colors.

R2-G2-B1 represents an arrangement when each of the first and second light sources 20R and 20G includes two light emitters R or G and the third light source 20B includes one light emitter B. In this case, the third light source 20B may be located between the two light emitters G forming the second light source 20G, and the second and third light sources 20G and 20B may be located between the two light emitters R forming the first light source 20R. The scattering pattern 13 is formed to achieve a uniform distribution of light in the main scanning direction M, which is emitted from the third light source 20B located at the center in the sub-scanning direction S from among the plurality of light sources 20. By virtue of this configuration, a uniform light distribution in the main scanning direction M may be achieved for beams of light of all colors.

R2-G2-B2 (a) and R2-G2-B2 (b) each represent an arrangement when each of the first through third light sources 20R, 20G, and 20B includes two light emitters R, G, or B. In R2-G2-B2(a), the two light emitters B forming the third light source 20B are located between the two light emitters G in the second light source 20G, and the second and third light sources 20G and 20B are located between the two light emitters R in the first light source 20R. Thus, the two light emitters R, G, or B forming each of the first through third light sources 20R, 20G, and 20B are symmetrically arranged in the sub-scanning direction S. The scattering pattern 13 is formed to achieve a uniform distribution of light in the main scanning direction M, which is emitted from the third light source 20B located at the center in the sub-scanning direction S from among the plurality of light sources 20. In R2-G2-B2 (b), the two light emitters G forming the second light source 20G are symmetrically arranged in the sub-scanning direction S to be symmetrical to each other, the two light emitters B in the third light source 20B are arranged below the two light emitters G in the height direction H orthogonal to the main scanning direction M and the sub-scanning direction S, and the second and third light sources 20G and 20B are located between the two light emitters R in the first light source 20R. Thus, the two light emitters R, G, or B forming each of the first through third light sources 20R, 20G, and 20B are symmetrically arranged in the sub-scanning direction S, to be respectively symmetrical to each other. The scattering pattern 13 is formed to achieve a uniform distribution of light in the main scanning direction M, which is emitted from the second and third light sources 20G and 20B located at the center in the sub-scanning direction S from among the plurality of light sources 20. By virtue of this configuration, a uniform light distribution in the main scanning direction M may be achieved for beams of light of all colors.

R2-G3-B2 represents an arrangement when each of the first and third light sources 20R and 20B includes two light emitters R or B and the second light source 20G includes three light emitters G. In this case, the three light emitters G forming the second light source G may be symmetrically arranged in the sub-scanning direction S to be respectively symmetrical to each other, each of the two light emitters B in the third light source 20B may be located between two of the three light emitters G in the second light source 20G, and the second and third light sources 20G and 20B may be located between the two light emitters R in the first light source 20R. The light emitters B, G, and R are sequentially arranged on either side in the sub-scanning direction S with respect to the light emitter G positioned at the center in the sub-scanning direction S. Thus, the two light emitters R, the three light emitters G, and the two light emitters B are respectively symmetrically arranged in the sub-scanning direction S to be symmetrical to each other. The scattering pattern 13 is formed to achieve a uniform distribution of light emitted from the light emitter G positioned at the center in the sub-scanning direction S from among the three light emitters G forming the second light source 20G. By virtue of this configuration, a uniform light distribution in the main scanning direction M may be achieved for beams of light of all colors.

R2-G3-B3 represents an arrangement when the first light source 20R includes two light emitters R and each of the second and third light sources 20G and 20B includes three light emitters G or B. In this case, the three light emitters G forming the second light source G are symmetrically arranged with respect to the sub-scanning direction S, the three light emitters B in the third light source 20B are respectively arranged below the three light emitters G in the height direction H orthogonal to the main scanning direction M and the sub-scanning direction S, the second and third light sources 20G and 20B are symmetrically located with respect to the first light source 20R in the height direction H, and each of the two light emitters R in the first light source 20R is located between two of the three light emitters G in the second light source 20G and two of the three light emitters B in the third light source 20B. Thus, the eight light emitters R, G, and B respectively forming the first through third light sources 20R, 20G, and 20B may be symmetrically arranged with respect to the sub-scanning direction S. The scattering pattern 13 is formed to achieve a uniform distribution of light in the main scanning direction M, which is emitted from the light emitters G and B located at the center in the sub-scanning direction S from among the second and third light sources 20G and 20B. By virtue of this configuration, a uniform light distribution in the main scanning direction M may be achieved for beams of light of all colors.

The plurality of light sources 20 may be arranged on either side of the light guide member 10 in the main scanning direction M. Also, in this case, two or more light emitters P emitting light of the same color from among the plurality of light sources 20 are symmetrically arranged in the sub-scanning direction S to be symmetrical to each other respectively.

It should be understood that examples described herein should be considered in a descriptive sense only and not for purposes of limitation. Descriptions of features in an example should typically be considered as available for other related features in another example. While one or more examples have been described with reference to the figures, it will be understood by those of ordinary skill in the art that various changes in form and details may be made therein without departing from the spirit and scope as defined by the following claims.

What is claimed is:

1. An illumination device for a scanner, the illumination device comprising:
a light guide member having a first side in a main scanning direction of the scanner and a second side in a sub-scanning direction of the scanner, the light guide member having a light exit portion provided at one end of the light guide member in the sub-scanning direction to allow light to exit; and
a plurality of light sources including first light emitters respectively to emit beams of light of a first color and a second light emitter to emit a beam of light of a second color different from the first color, toward an inside of the light guide member, via the second side of the light guide member, and in the main scanning direction,
wherein the first light emitters are positioned in the sub-scanning direction and positioned to be symmetrical to each other.

2. The illumination device of claim 1, wherein
the light guide member comprises a scattering pattern that is provided at a position opposite to the light exit portion through which light is to pass toward the light exit portion.

3. The illumination device of claim 2, wherein
the scattering pattern is to scatter light in a uniform distribution in the main scanning direction, when the light is emitted from a light source located at a center in the sub-scanning direction from among the plurality of light sources.

4. The illumination device of claim 3, wherein the plurality of light sources comprises a first light source, a second light source and a third light source respectively to emit red light, green light, and blue light, and
wherein at least one of the first light source, the second light source and the third light source includes two or more light emitters.

5. The illumination device of claim 4, wherein
at least one of the first light source and second light source includes more light emitters than the third light source.

6. The illumination device of claim 4, wherein
the second light source includes a plurality of light emitters.

7. The illumination device of claim 4, wherein
each of the first and third light sources includes one light emitter,
the second light source includes two light emitters, and
the first light source and third light source are arranged in a height direction orthogonal to the main scanning direction and the sub-scanning direction and are located between the two light emitters included in the second light source.

8. The illumination device of claim 4, wherein
the first light source includes two first source light emitters,
the second light source includes two second source light emitters,
the third light source includes one third source light emitter,
the third light source is located between the two second source light emitters included in the second light source, and
the second and third light sources are located between the two first source light emitters included in the first light source.

9. An image reading module couplable to a scanner comprising:
an illumination device to irradiate a document with light, the illumination device including:
a light guide member having a first side in a main scanning direction and a second side in a sub-scanning direction, the light guide member having a light exit portion provided at one end of the light guide member in the sub-scanning direction to allow light to exit toward the document, and
a plurality of light sources including first light emitters respectively to emit beams of light of a first color and a second light emitter to emit a beam of a second color different from the first color, toward an inside of the light guide member, via the second side of the light guide member, and in the main scanning direction, the first light emitters positioned in the sub-scanning direction and positioned to be symmetrical to each other;
an image sensor having a side in the main scanning direction; and
an imaging optical system to focus light reflected from the document onto the image sensor.

10. The image reading module of claim 9, wherein
the light guide member comprises a scattering pattern that is provided at a position opposite to the light exit portion through which light is to pass toward the light exit portion.

11. The image reading module of claim 10, wherein
the scattering pattern is to scatter light in a uniform distribution in the main scanning direction, when the light is emitted from a light source located at a center in the sub-scanning direction from among the plurality of light sources.

12. The image reading module of claim 11, wherein the plurality of light sources comprise a first light source, a second light source and a third light sources respectively to emit red light, green light, and blue light, and
wherein at least one of the first light source, the second light source and the third light source includes two or more light emitters.

13. A scanner comprising:
a document board on which a document is to be placed; and
an image reading module including:
an image sensor, and
an imaging optical system to focus light reflected from the document onto the image sensor, to imaging optical system to move in a sub-scanning direction; and
an illumination device to irradiate the document with light, the illumination device including:
a light guide member having a first side in a main scanning direction of the scanner and a second side in the sub-scanning direction of the scanner, the light guide member having a light exit portion provided at one end of the light guide member in the sub-scanning direction to allow light to exit toward the document, and
a plurality of light sources including first light emitters respectively to emit beams of light of a first color and a second light emitter to emit a beam of a second color different from the first color, toward an inside of the light guide member, via the second side of the light guide member, and in the main scanning direction,
wherein the first light emitters are positioned in the sub-scanning direction to be symmetrical to each other.

14. The scanner of claim 13, wherein
the light guide member comprises a scattering pattern that is provided at a position opposite to the light exit portion through which light is to pass toward the light exit portion.

15. The scanner of claim 14, wherein
the scattering pattern is to scatter light in a uniform distribution in the main scanning direction, when the light is emitted from a light source located at a center in the sub-scanning direction from among the plurality of light sources.
